(19) United States
(12) Patent Application Publication
(10) Pub. No.: US 2007/0268701 A1
(43) Pub. Date: Nov. 22, 2007

(54) Motorized lamp axis assembly

(76) Inventor: Thomas E. Devlin, Winchester, MA (US)

Correspondence Address: LEE WEINSTEIN, 32A FAIRMONT STREET, ARLINGTON, MA, 02474, US

(21) Appl. No.: 11/803,838

(22) Filed: May 16, 2007

Related U.S. Application Data
(60) Provisional application No. 60/801,327, filed on May 17, 2006.

(51) Int. Cl. F21V 21/26

(52) U.S. Cl. 362/272

(57) ABSTRACT

A method and apparatus of motorizing pan and tilt axes of existing track lighting fixture designs for minimal cost and with minimal impact on existing aesthetic design is presented. The inherently-built-in clutch of this design allows manual adjustment of lamp orientation as well as motorized adjustment, and obviates the need for expensive current limit circuitry and/or limit switches in the design. A beveled-gear embodiment provides for easy fine-tuning of the axial position of the beveled gearmotor output gears, which facilitates precise gear meshing even with large mechanical tolerance stack-up.

### CROSS-REFERENCE TO RELATED PATENT APPLICATIONS

This patent application claims priority to provisional patent application No. 60/801,327, filed May 17, 2006, which is incorporated herein by reference.

### FIELD OF THE INVENTION

The field of the invention relates to track lighting and to remote-controlled lights, and more specifically to lights which have motorized pan and tilt functions.

### BACKGROUND OF THE INVENTION

Track-mounted lighting fixtures typically have two adjustable axes, pan and tilt. Typically such fixtures are designed such that the optical direction of the fixture lamp head may be adjusted by manually rotating the lamp head about these two axes. Such fixtures are typically designed to provide friction about the two axes of adjustment such that the coefficient of friction may be overcome by hand to orient the lamp head, and subsequent to the lamp head being oriented, the friction is sufficient to hold the lamp head as oriented indefinitely. Typically there are two classes of adjustable axis designs employed in commercial lamp modules: axes with lamp power passing through, and axes without.

Typically, to implement power passing through an axis, a hollow threaded pipe with a flanged end is inserted through a hole in the rotatable portion of the fixture, and through an opening in the fixed housing. Thus such a threaded pipe might, for example, pass through a hole in the arm of the ‘pan’ axis, and through a hole in the wall of the housing of the track attachment. One of these openings is typically keyed to not allow rotation, and on this side a nut and lock washer squeeze the assembly together to provide an amount of friction that may be overcome manually to adjust the orientation of the lamp. The amount of friction is typically regulated by a wave washer or the like.

For an axis without power passing through, the industry uses a whole multitude of solutions. All provide a regulatable amount of rotational friction about the axis of orientation adjustment. Typically such friction is applied in a way that does not loosen when the lamp is oriented manually. Simple rivets, screws with lock washers, keyed and threaded rods are some examples of how regulated friction is provided. Most gimbaled designs use this method.

The typical method known in the art for creating a motorized lamp orientation adjustment axis employs a gear attached to a rod that is supported by two bearings. This gear engages to a gear motor. A wire may be passed through the rod by making the rod hollow. A lamp or arm is attached to the output of this rod. This sort of assembly has special mechanical requirements, and does not conveniently allow for manual adjustability. Such a motorized axis may be difficult to attach on the output side because lamps may have special shapes and confined spaces.

As noted in U.S. Pat. No. 6,655,817, there is a need for commercial track lighting fixtures that can be conveniently adjusted by remote control. The need for a lamp to be remote-controllable is not, however, always considered the overriding need. Management of a particular retail establishment may in fact select lamp modules based on aesthetic considerations, and there may be many situations in which a retail establishment or the like would like to have some lamps remote-controllable, and some not, and where it is desired that all lamps are of a single and/or particular aesthetic design. Thus, there is a need for a method and apparatus that can be used to provide motorized adjustability to existing lamp designs with minimal modification of such designs.

There is a further need for a method and apparatus that provides motorized adjustability of lighting fixture orientation while still allowing for manual adjustability.

### SUMMARY OF THE INVENTION

It is an object of the present invention to provide motorized adjustability to existing lamp designs with minimal modification of such designs. It is a further object of the present invention to provide motorized adjustability of lighting fixture orientation while still allowing for manual adjustability.

The present invention makes use of industry standard methods of attaching a lamp axis to create a motor actuated axis, by attaching an adjustment gear to the movable lamp head in the way now used to attach the movable lamp head to the fixed lamp housing.

One can think of the present invention as comprising modifying a typical track lamp according to the following three steps:

Step 1—Use the typical rotating ‘head to housing’ attachment method to attach ‘head to gear’, and trap that gear in the first housing creating one bearing. Size the gear to be large enough to fit the hardware such as nut and washer. (Advantage: attachment is done on the motor side of the axis, where there is room.)

Step 2—Locate the motor on the side and out of way of wires passing through. This can be done ideally with a bevel gear at right angles to the axis, but is also possible with spur gears in parallel. This motor can be very small, because very little power is needed to rotate a lamp at 5-10 rpm.

Step 3—For added stability, create a second bearing if required with the motor mounting bracket. This saves space and parts.

Motorized axes according to the present invention require very little space, maintain manual adjustability, and inherently incorporate a clutch between the motor and output, so that if the rotating element encounters an obstacle, the axis will simply slip, preventing damage to the motor and gears. This last advantage allows for a ‘dumb’ motor driver that will not require over-current protection, limit switches, or encoders.

Using the present invention, manufacturers can easily adapt an existing design for motor actuation.

An additional bearing may optionally be created on the opposite side of the head, such as in a gimbaled arrangement.

### BRIEF DESCRIPTION OF THE DRAWINGS

FIG. 1 depicts a typical low voltage track lighting fixture that has been modified to be motorized. This is a very small fixture and was chosen to illustrate how this motor system can fit virtually any lamp.

FIG. 2 a cut-away of the track fixture of FIG. 1. Most wiring is not shown for clarity.

FIG. 3 is an exploded view of the low voltage fixture cut-away.

FIG. 4A is a typical lamp axis mount with wire pass-through.

FIG. 4B is a modified axis mount for use with motor actuation, where the motor is mounted internal to the housing. This is a detailed cut-away of the lamp pan axis.

FIG. 5A a typical lamp axis mount using a rivet, with no wire passing through the axis.

FIG. 5B is a modified axis mount for use with motor actuation using a rivet. This is a detail cutaway of the tilt axis.

FIG. 6 depicts a method for attaching a motor to a hollow lamp axis where beveled gears are not used.

### DETAILED DESCRIPTION OF SOME PREFERRED EMBODIMENTS

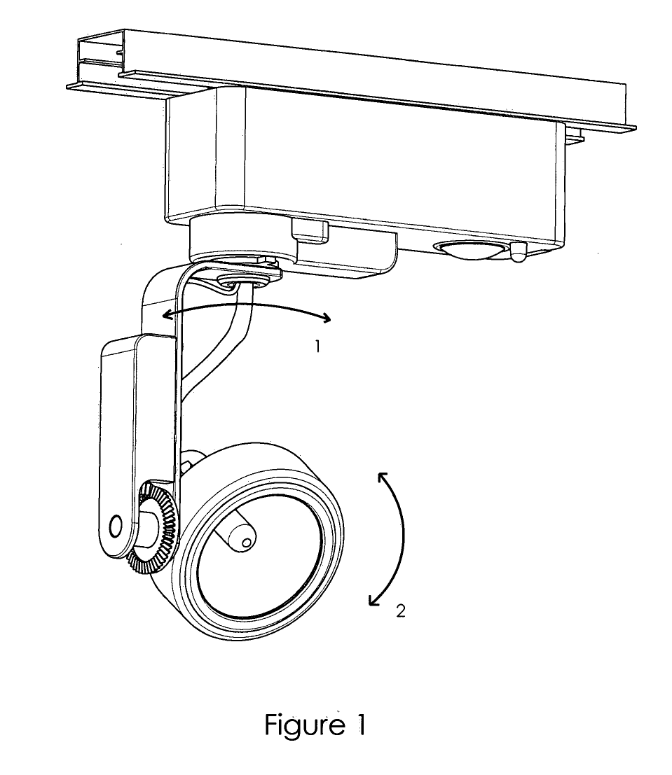

FIG. 1 depicts a typical low voltage track lighting fixture that has been modified for motorized actuation of pan axis 1 and tilt axis 2. This is a very small fixture and was chosen to illustrate how this motor system can fit virtually any lamp.

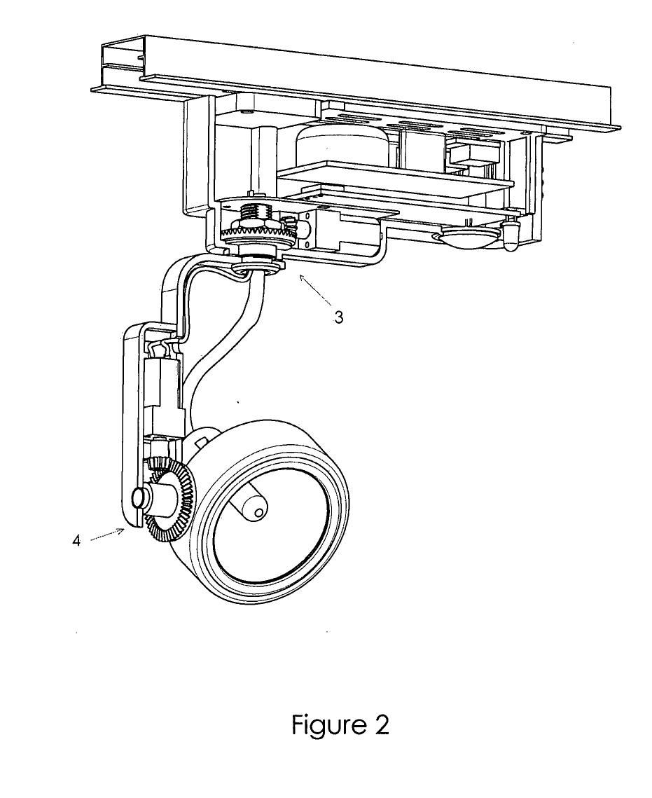

FIG. 2 is a cut-away of FIG. 1, showing pan axis motor gear assembly 3 and tilt axis motor gear assembly 4.

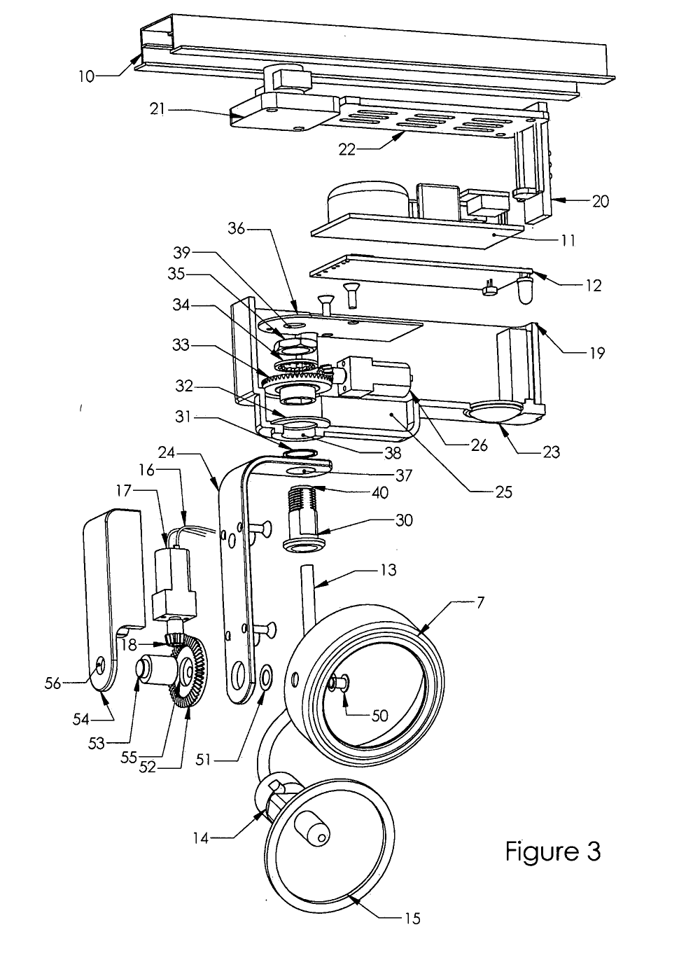

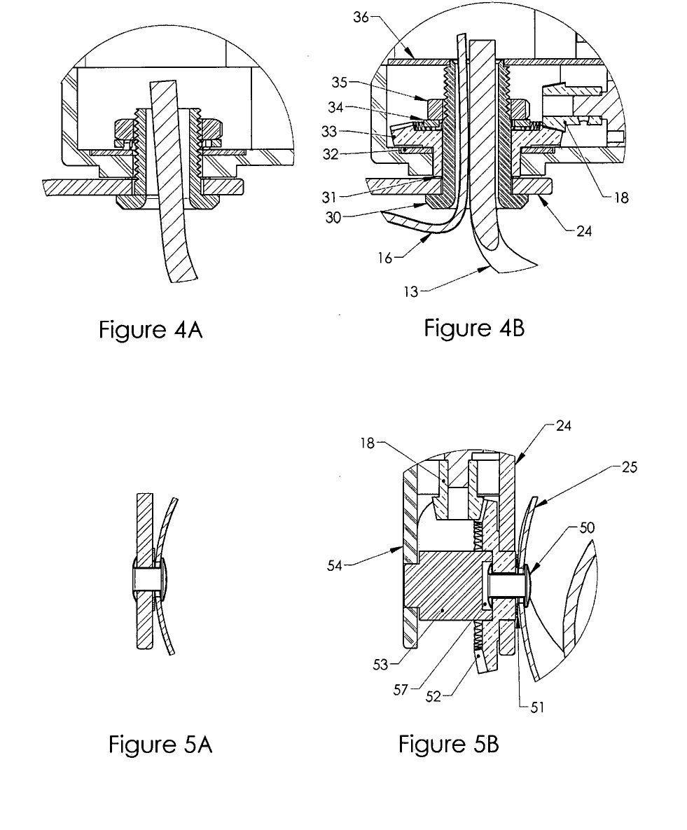

FIG. 3 is an exploded view of the lamp assembly shown in FIG. 1. Track mount 21 (in cooperation with latch 20) mounts housing 19 to track 10, and serves as an electrical connector to supply track power to socket 14 and low-voltage power supply and/or lamp control circuitry 11. Motor control Board 12 receives optical control signals through control window 23. Housing top 22 may be ventilated to facilitate heat exchange from power supply circuitry 11.

Motor control board 12 controls tilt motor 17 through tilt motor wiring 16. In a preferred embodiment, tilt motor 17 is a miniature gearmotor, whose output gear 18 rotates at a rate in the range of 30 revolutions per minute. In a preferred embodiment, motor 26 is identical in construction to tilt motor 17. Pan motor 26 drives pan axis drive gear 33 which has a shoulder designed to sit on the bearing surface of thrust washer 32. Pan axis drive gear 33 is keyed in the center to lock with threaded pipe 30. In a preferred embodiment, pan axis drive gear 33 and tilt axis drive gear 52 provide a four to one reduction in the rotational rates of the output shafts of pan motor 26 and tilt motor 17, respectively, providing rotational rates of the pan and tilt axes of seven to eight revolutions per minute during actuation. In a preferred embodiment, molded feature 25 in housing 19 holds Pan motor 26 in place.

Lamp power cable 13 conducts power from low voltage power supply 11 to socket 14. In hollow-axis embodiments of the present invention such as depicted in FIG. 3, power cable 13 runs through the center of the pan axis of the lamp assembly.

In a preferred embodiment, tilt axis drive gear 52 has a space that allows for the head of rivet 50, which attaches lamp holder 7 (which contains lamp 15 and socket 14) to tilt axis drive gear 52.

In a preferred embodiment, motor mount bracket 36 holds pan motor 26 in a pocket formed in plastic housing 19. In a preferred embodiment, wave washer 31 provides regulated rotational friction about the pan axis of the assembly. In a preferred embodiment, pan bearing 38 is formed in the wall of plastic housing 19. Keyed, threaded, flanged pipe 30 passes through hole 37 in pan axis arm 24. In alternate embodiments, wave washer 31 may be a different type of compressible member, such as a coil spring, a foam washer, a rubber washer, an o-ring, or the like.

In a preferred embodiment, tilt bearing 56 is formed in the wall of tilt motor box 54, which may be made of plastic, die-cast metal, or some other suitable material. Axle 53 engages in counter bore 55 of tilt axis drive gear 52, and rides on bearing surface 56 of tilt motor housing 54. Tilt motor housing 54 locates tilt motor 17 in place and covers motor wires 16. In some embodiments, wave washer 51 may be provided to regulate rotational friction about the tilt axis. In a preferred embodiment, a counter bore in axle 53 provides clearance for the head of rivet 50, which assembles the tilt axis through pan arm 24.

In a preferred embodiment, the pan axis is assembled by passing threaded, keyed, flanged tube 30 through wave washer 31, thrust washer 32, pan axis drive gear 33, lock washer 34 and nut 35. Nut 35, tightened against lock washer 34 puts pressure on wave washer 31 to provide regulated friction about the pan axis. In a preferred embodiment, shoulder 40 of threaded pipe 30 passes through motor mount bracket 36, forming a second bearing for the pan axis.

In the above described embodiment, it should be noted that the pan and tilt motors are each secured in a mechanical pocket such that each can only slide along its own axis. In a preferred embodiment, an adjustment mechanism may be provided to make fine post-assembly adjustments of the positions of the gearmotors along their axes to take up tolerance variations in the mechanical assemblies. In some embodiments where the gearmotor is slidable along the axis of its output gear, a spring may be added at the opposite end of the gearmotor from the gearmotor's output gear, and the gearmotor's output gear may thereby automatically as closely engaged as possible to the axis drive gear, providing minimum backlash and automatic positioning of the gearmotor regardless of mechanical tolerance stack-up.

In a preferred embodiment motor controller Board 12 is designed to operate at the same voltage as low-voltage lamp 15. This aids in easily adapting the present invention to existing low-voltage lamp fixtures.

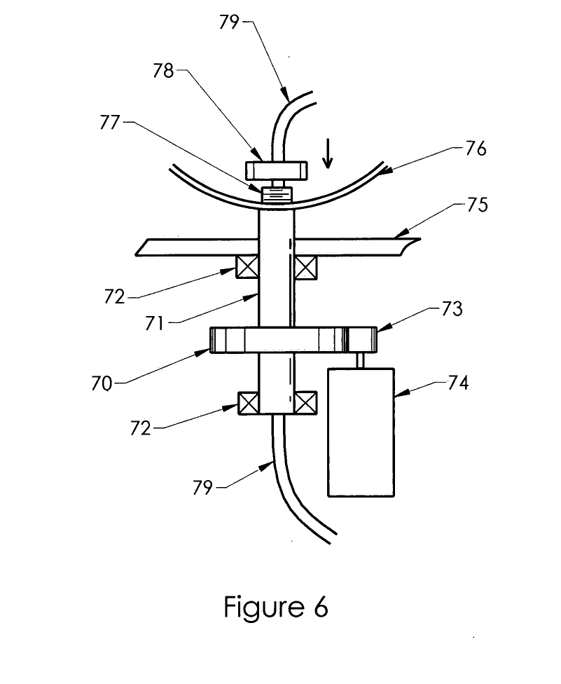

FIG. 6 depicts a more cumbersome method for attaching a motor to a hollow lamp axis where beveled gears are not used, and the rotational axis of the output gear of gearmotor 74 is parallel to the rotational axis of axis drive gear 70. Axis drive gear 70 engages motor gear 73 which is directly attached to the output shaft of motor 74. Hollow shaft 71 passes through bearing 72 and housing 75, and is assembled to lamp head 76 by threading nut 78 to threaded end 77 of hollow shaft 71. Lamp wire 79 passes through hollow shaft 71.

The foregoing discussion should be understood as illustrative and should not be considered to be limiting in any sense. While this invention has been particularly shown and described with references to preferred embodiments thereof, it will be understood by those skilled in the art that various changes in form and details may be made therein without departing from the spirit and scope of the invention as defined by the claims.

What is claimed is:

1. A method of adapting a light fixture assembly for motorized control about an axis, comprising:
Surrounding said axis with an axis drive gear;
Providing a gearmotor with an output gear operably engaged with said axis drive gear;
Frictionally coupling said axis drive gear to an assembly to be oriented about said axis.

2. A lighting fixture comprising:
A gear encircling a drive axis;
A lamp assembly rotatable about said drive axis and frictionally coupled to said gear;

3. The lighting fixture of claim 2, further comprising:
A circular bearing surface which directly or indirectly positions said gear, is co-axial with said gear, and mechanically constrains the position of said gear axially.

4. The lighting fixture of claim 3, wherein a threaded pipe passes through said gear, through said bearing surface, through a nut, and through a hole in said lamp assembly.

5. The lighting fixture of claim 4, wherein said threaded pipe also passes through a compressible member which may be compressed by tightening said nut to provide a regulated amount of rotational friction between said lamp assembly and said bearing surface about said axis.

6. The lighting fixture of claim 5, wherein said threaded pipe is keyed to said gear such that said threaded pipe is rotationally fixed with respect to said gear.

7. The lighting fixture of claim 5, wherein said threaded pipe has a shoulder feature at one and which engages a second bearing surface co-axial with said first bearing surface.

8. The lighting fixture of claim 5, further comprising a housing, and wherein a portion of said bearing surface comprises a hole through said housing.

9. The lighting fixture of claim 2, further comprising a housing and a gearmotor with an output gear, wherein said housing includes a mechanical feature which holds said gearmotor on a fixed axis of alignment coincident with the axis of said output gear, while allowing for positional adjustment of said gear motor along said fixed axis of alignment.

10. A lighting fixture comprising:
A first beveled gear encircling a drive axis;
A lamp assembly rotatable about said drive axis and frictionally coupled to said gear;
A gearmotor with a mechanical output comprising a second beveled gear arranged to engage said first beveled gear, said gearmotor slidably positionable along the axis of said second beveled gear.
